(19) United States
(12) Patent Application Publication
(10) Pub. No.: US 2009/0265178 A1
(43) Pub. Date: Oct. 22, 2009

(54) Referral Lists for Tracking Distributed Content

(75) Inventors: Clifford P. Strom, Sammamish, WA (US); Quintin S. Burns, Fort Mills, SC (US); Kedarnath A. Dubhashi, Redmond, WA (US); Shalendra Chhabra, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/104,416

(22) Filed: Apr. 16, 2008

(51) Int. Cl. G06Q 30/00; G06F 15/16

(52) U.S. Cl. 705/1; 709/201

(57) ABSTRACT

Various embodiments described above can enable referral lists to be used in connection with distributed content to protect a referral infrastructure that is used with such content. In at least some embodiments, referral lists are protected using digital rights management (DRM) techniques. The DRM techniques can be used for a number of purposes including securely establishing a referring consumer, securely maintaining a chain of referring entities through distribution tracking, and maintaining control over the referral lists associated with distributed content. In at least some embodiments, DRM techniques are utilized to protect referral lists that are used in multi-level marketing networks.

### BACKGROUND

As consumers utilize electronic commerce (eCommerce) more widely to purchase and distribute content, it becomes increasingly more important to be able to protect purchased and distributed content. This is particularly the case as new business models evolve that enable consumers to purchase and distribute such content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable referral lists to be used in connection with distributed content to protect a referral infrastructure that is used with such content. In at least some embodiments, referral lists are protected using digital rights management (DRM) techniques. The DRM techniques can be used for a number of purposes including securely establishing a referring consumer, securely maintaining a chain of referring entities through distribution tracking, and maintaining control over the referral lists associated with distributed content.

In at least some embodiments, DRM techniques are utilized to protect referral lists that are used in multi-level marketing networks. In these embodiments, a referral list describes a distribution chain that includes one or more entities known as “referrers”. A referrer is a person or persons who refer content to another person or persons. By providing a protected distribution chain as represented in a referral list, various business models directed to incentivizing referrers can be securely implemented.

### BRIEF DESCRIPTION OF THE DRAWINGS

The same numbers are used throughout the drawings to reference like features.

FIG. 1 illustrates an operating environment in accordance with one or more embodiments.

FIG. 2 illustrates an example referral list in accordance with one or more embodiments.

FIG. 3 illustrates a content assembly that includes a referral list and associated content in accordance with one or more embodiments.

FIG. 4 illustrates a system in which a referral list can be processed in accordance with one or more embodiments.

FIG. 5 is a flow diagram that describes steps in a method in accordance with one or more embodiments.

FIG. 6 is a flow diagram that describes steps in a method in accordance with one or more embodiments.

FIG. 7 illustrates a system in accordance with one or more embodiments.

FIG. 8 is a block diagram of an example system that can be utilized to implement one or more embodiments.

### DETAILED DESCRIPTION

Overview

Various embodiments enable referral lists to be used in connection with distributed content to protect a referral infrastructure that is used with such content. In at least some embodiments, referral lists are protected using digital rights management (DRM) techniques. The DRM techniques can be used for a number of purposes including securely establishing a referring consumer, securely maintaining a chain of referring entities through distribution tracking, and maintaining control over the referral lists associated with distributed content.

In at least some embodiments, DRM techniques are utilized to protect referral lists that are used in multi-level marketing networks. In these embodiments, a referral list describes a distribution chain that includes one or more entities known as “referrers”. A referrer is a person or persons who refer, give or otherwise distribute content to another person or persons. By providing a protected distribution chain as represented in a referral list, various business models directed to incentivizing referrers can be securely implemented.

The various embodiments described below are particularly well suited for domain-based content. Domain-based content is content that is able to be rendered, e.g., played, on any device in a particular domain. Domains may contain arbitrary numbers of devices, depending upon the policy of the service hosting the domain infrastructure. An example of a domain would be “all devices within a single household”.

It is to be appreciated and understood, however, that the various embodiments can be used with content other than domain-based content.

In the discussion that follows, a section entitled “Operating Environment” describes but one operating environment that can be utilized to practice the inventive principles described herein in accordance with one or more embodiments. Following this, a section entitled “Referral Lists in a DRM System-Example” describes how referral lists can be used in a DRM system in accordance with one or more embodiments. Next, a section entitled “Example Methods” describes example methods in accordance with one or more embodiments. Following this, a section entitled “Implementation Example” describes an example implementation in accordance with one or more embodiments. Next, a section entitled “Example Implementation Method” describes an example implementation method in accordance with one or more embodiments. Following this, a section entitled “Combining Multiple Referral Lists” describes how referral lists can be combined in accordance with one or more embodiments. Next, a section entitled “Generating a Referral List On-the-Fly” describes how referral lists can be generated in accordance with one or more embodiments. Last, a section entitled “Example System” describes an example system that can be utilized to implement one or more embodiments.

Operating Environment

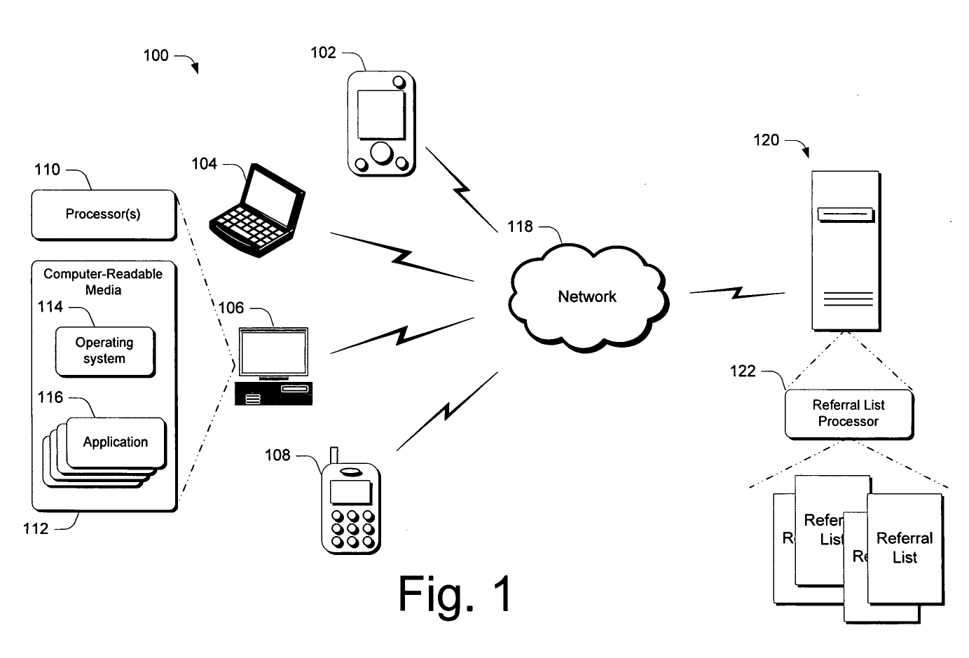

FIG. 1 illustrates an operating environment in accordance with one or more embodiments, generally at 100. Operating environment 100 includes multiple different computing devices, examples of which are shown at 102, 104, 106, and 108. The computing devices can be used by various users to consume licensed content, examples of which can include textual content, video content, audio content, audio/visual content such as various types of multimedia content including games, and the like. Individual computing devices can typically include one or more processors 110, one or more computer-readable media 112, an operating system 114 and one or more applications 116 that reside on the computer-readable media and which are executable by the processor(s). Applications 116 can include an application that enables a user to consume licensed content. Such application can include, by way of example and not limitation, a media playing application or any other type of application that can enable distributed content to be consumed by a user.

The computer-readable media can include, by way of example and not limitation, all forms of volatile and non-volatile memory and/or storage media that are typically associated with a computing device. Such media can include ROM, RAM, flash memory, hard disk, removable media and the like.

In addition, environment 100 includes a network 11 8, such as a local network or the Internet, via which licensed content can be received. Licensed content can be received from any suitable source. For example, in at least some embodiments, licensed content can be received from other users-referred to as “referrers”, such as those using one of computing devices 102, 104, 106, and 108.

Licensed content and other data or information can be received over network 118 by way of a server 120 that has access to the content and/or information associated with the content. In the illustrated and described embodiment, server 120 can include a referral list processor 122 that can process referral lists associated with distributed content, manipulate the referral lists in some way, and return the referral lists to one or more of computing devices 102, 104, 106, and 108, as will be described below in more detail.

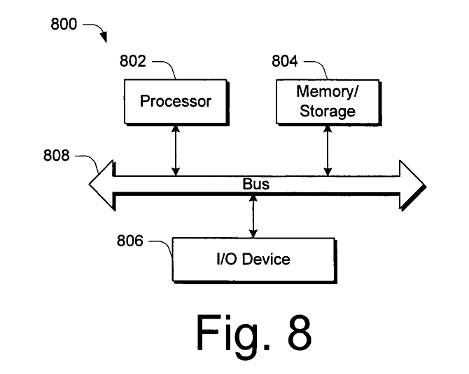

The computing devices can be embodied as any suitable computing device such as, by way of example and not limitation, a desktop computer (such as computing device 106), a portable computer (such as computing device 104), a handheld computer such as a personal digital assistant (such as computing device 102), a cell phone (such as computing device 108), and the like. One example of a computing device is shown and described below in relation to FIG. 8.

Having discussed the general notion of an example operating environment in which various embodiments can operate, consider now a discussion of referral lists and how those referral lists can be used in connection with a digital rights management (DRM) system in accordance with one or more embodiments.

Referral Lists in a DRM System—Example

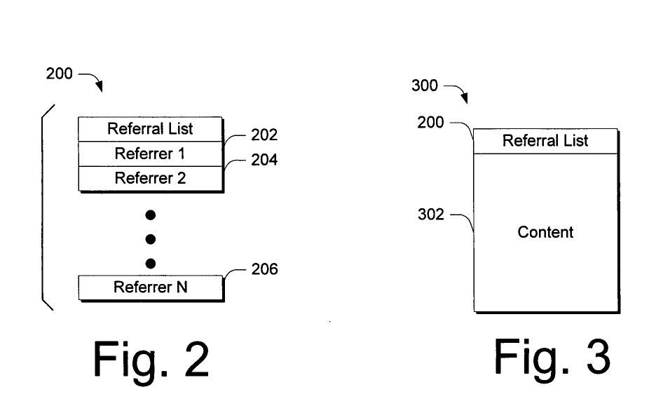

Consider first the notion of a referral list. FIG. 2 illustrates an example referral list in accordance with one or more embodiments generally at 200. In this example, referral list 200 includes a number of different referrers 202, 204, and 206. A referral list can include any suitable number of referrers. In at least some embodiments, the number of referrers that appear on a referral list can be capped, e.g., no more than five referrers. In use, the referral list is used to track consumers who refer a particular piece of content to another consumer. For example, Referrer 1 may have referred a particular piece of content to Referrer 2, Referrer 2 may have referred the particular piece of content to another consumer who will then appear on the referral list and so on. Thus, the referral list establishes a chain of referring entities for a particular piece of content.

In one or more embodiments, each referrer appearing in a referral list can be identified by a unique identifier. Any suitable unique identifier can be used. For example, a referrer can be identified by a unique account ID such as, for example, a 16-byte domain account ID associated with a particular domain. Additionally, as noted above, the order in which referrers appear on the referral list describes the ordering of the referral. For example, Joe may have purchased a piece of content by purchasing a license for the content. Joe may then have referred this content to Alice who also purchased a license. Alice, in turn, may then have referred the content to Bob who also purchased a license for the content. In this case, Bob will head the referral list, followed by Alice and then Joe. If Bob were to then refer the content to another user, then the next user would appear at the top of the referral list followed by Bob, Alice and Joe.

In at least some embodiments, the referral list is embedded in the content with which it is associated. As an example, consider FIG. 3. There, a content assembly is shown generally at 300 and includes a referral list 200 and the actual content 302 with which the referral list is associated. The referral list can be embedded in any suitable way using any suitable techniques. For example, in at least some embodiments, the referral list comprises part of a header associated with content 302.

Having now considered the notion of a referral list and how a referral list can be associated with content, consider how the referral list can be processed to securely establish an individual referrer and securely maintain a chain of referring entities.

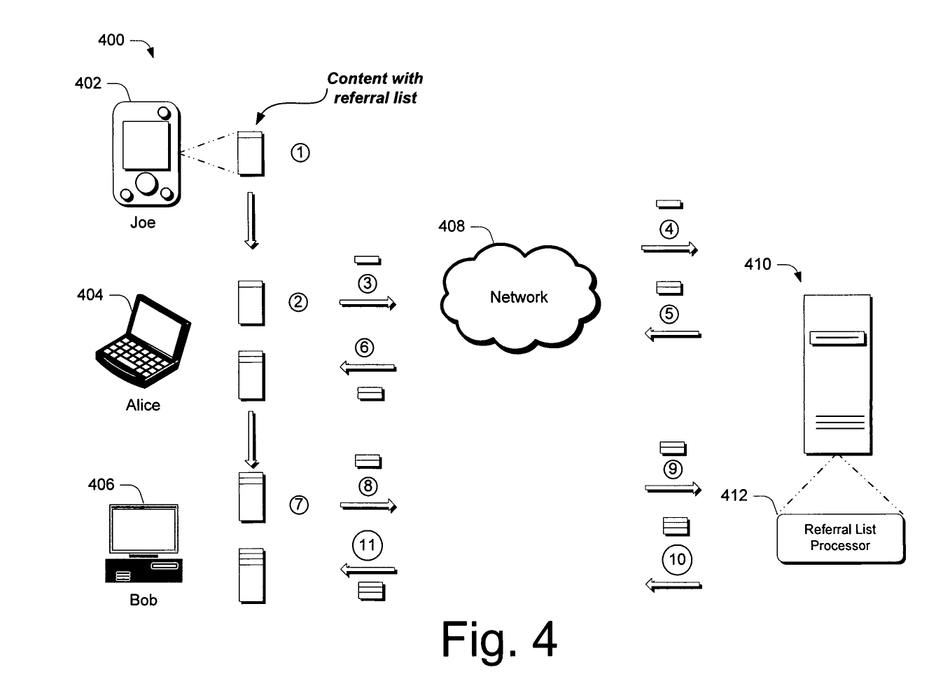

FIG. 4 illustrates a system, generally at 400, in which a referral list can be processed in accordance with one or more embodiments. In this particular example, three different computing devices 402, 404, and 406 are shown. Computing device 402 belongs to Joe, computing device 404 belongs to Alice, and computing device 406 belongs to Bob. In addition, system 400 includes a network 408 such as the Internet and a server 410 such as a license server that includes a referral list processor 412.

Assume in this example that Joe has a piece of content with a referral list at “1”. In Joe's referral list, Joe's name appears at the top of the referral list. Assume now that Joe refers this content to Alice at “2”, as by providing Alice a digital copy of the content. Alice now has Joe's content along with its associated referral list. In accordance with one or more embodiments, software executing on Alice's machine accesses the referral list and sends the referral list at “3” to server 410. Server 410 receives the referral list at “4”. At this point, the server knows from the referral list that Joe has referred his content to Alice. This is because the referral list includes an ID associated with Joe, and information that indicates the referral list was received from Alice.

At this point, the server can use this knowledge to apply any particular policies associated with the referral list using the referral list processor 412. For example, in at least some embodiments, the server can use the referral list to credit Joe with a referral. This credit can take any suitable form such as, by way of example and not limitation, monetary compensation, points awards, credit awards that can be used to purchase other goods and/or services, and the like. It is to be appreciated and understood that the server can implement any suitable policy in connection with any suitable business model that has been designed to use referral lists.

When the server receives the referral list from Alice at “4”, it can manipulate the referral list to add Alice to the top of the referral list. After Alice is added to the top of the referral list, the referral list is sent, at “5”, back to Alice. The referral list is received by Alice at “6”, and embedded back into the content that Alice received from Joe. Assume now that Alice refers this content to Bob at “7”. When Bob receives this content, software executing on Bob's computing device accesses the referral list and sends the referral list, at “8”, to server 410. Server 410 receives the referral list at “9” and processes the referral list using referral list processor 412. Processing of the referral list can take place as described above. Specifically, the referral list can be manipulated by adding Bob to the top of the referral list and returning the referral list, at “10”, to Bob. When Bob receives the referral list at “11”, the referral list is embedded back into the content.

At this point, content with an associated referral list has been referred to two additional users—Alice and Bob. With each referral, the referral list has been updated to reflect who referred the content to whom. In addition, in at least some embodiments, server 410 has been able to use the referral lists to apply whatever policies it has to reward the referrers.

Example Method

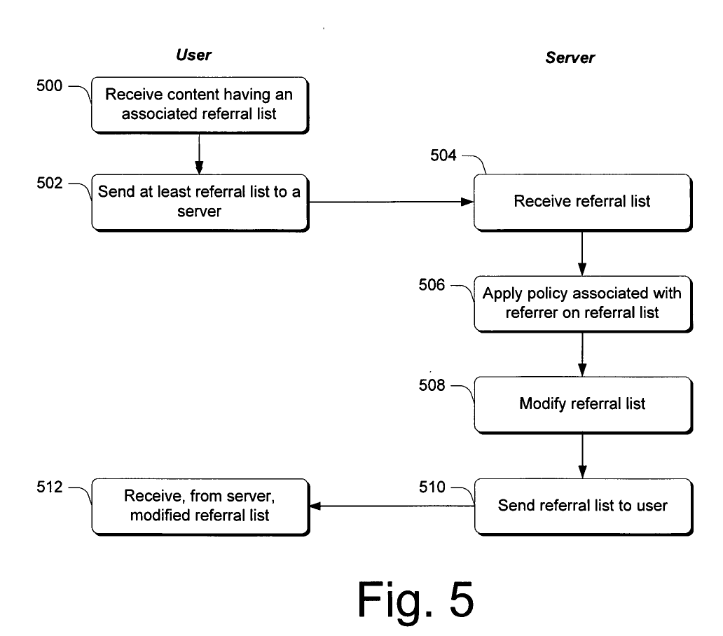

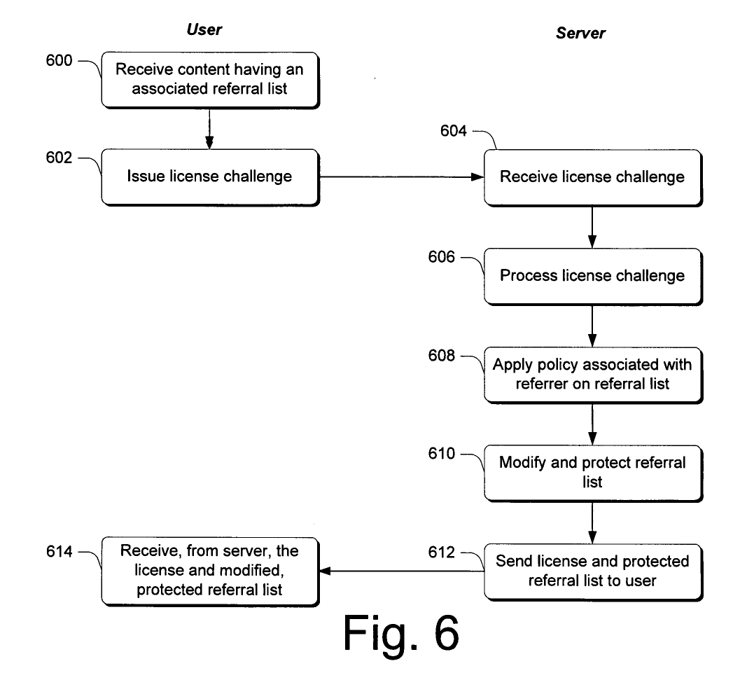

FIG. 5 is a flow diagram that describes steps in a method in accordance with one or more embodiments. The method can be implemented in connection with any suitable hardware, software, firmware, or combination thereof. In at least some embodiments, aspects of the described method can be implemented by software executing on a user's computing device. These aspects appear under the heading “User”. Likewise, aspects of the described method can be implemented by software executing on a suitably-configured server. These aspects appear under the heading “Server”.

Step 500 receives content having an associated referral list. The referral list can be associated with the content in any suitable way. For example, in at least some embodiments, the referral list can be embedded in the content itself. The referral list can, however, be associated with the content in other ways. For example, the referral list can be maintained in an associated file that moves as the content moves. Alternately or additionally, the referral list can be maintained on a server, and a “Referral List ID” can be maintained in the content. The ID would generally not change except perhaps for a first referral where an ID does not yet exist. For each transaction with the server, the server can receive the Referral List ID, retrieve the referral list from a server database, update the list, and save the list back to the database. In this case, the client would not receive an updated list or need to update the content again.

In the present example, the referral list includes an ID associated with a source, e.g., a user or entity from whom or which the content was received. Step 502 sends at least the referral list to a server.

Step 504 receives, at the server, the referral list. Step 506 applies policy associated with one or more referrers on the referral list. Examples of policy that can be applied are provided above. In addition, policies can include revenue sharing that is spread amongst referers appearing on the referral list. For example, the top referrer might receive a larger percentage of a license fee than those referers appearing below the top referrer. Step 508 modifies the referral list as by inserting, at the top of the list, the user from whom the referral list was received. Step 510 sends the referral list back to the user.

Step 512 receives, from the server, the modified referral list. At this point, software executing on the recipient's computing device can reassociate the referral list with its associated content. For example, in at least some embodiments, the modified referral list can be re-embedded in the content or associated in some other way.

Having considered example systems and methods that can be utilized in accordance with one or more embodiments, consider now an implementation example.

Implementation Example

In this example, referral lists are processed in connection with a license acquisition process. License acquisition processes are typically used when a client or user does not have all of the licenses that are needed to consume a particular piece of content.

So, for example, when a user receives referred content, software executing on the user's computing device makes what is known as a license challenge and contacts a server to provide the server with information that it needs to issue a license. This information can include an identification of the content as well as an identification of the user associated with the content. During the license challenge process, the referral list that accompanied the referred content is also provided to the server and processed as described above. At this point, the server can, if it so desires, charge a fee for a license or implement whatever type of policy it has with respect to the particular piece of content and the user. The server can then return a license to the user from whom the license challenge was issued, along with a modified referral list.

In at least some embodiments, the server is configured to apply protections to the referral list to ensure that unauthorized entities are unable to manipulate the content of the referral list. For example, the server can cryptographically hash or sign the referral list with a secret key that is known only to the server or license issuer. In these embodiments, the referral list is not changable by users who receive the referral list.

Example Implementation Method

FIG. 6 is a flow diagram that describes steps in a method in accordance with one or more embodiments. The method can be implemented in connection with any suitable hardware, software, firmware, or combination thereof. In at least some embodiments, aspects of the described method can be implemented by software executing on a user's computing device. These aspects appear under the heading “User”. Likewise, aspects of the described method can be implemented by software executing on a suitably-configured server. These aspects appear under the heading “Server”.

Step 600 receives content having an associated referral list. The referral list can be associated with the content in any suitable way. For example, in at least some embodiments, the referral list can be embedded in the content itself. The referral list can, however, be associated with the content in other ways, examples of which are provided above. In the present example, the referral list includes an ID associated with a source, e.g., a user or entity from whom or which the content was received. Step 602 issues a license challenge. In at least some embodiments, part of the license challenge process comprises providing the referral list to the server. In this particular embodiment, the referral list has been protected by the server to prevent unauthorized entities from modifying the referral list.

Step 604 receives, at the server, the license challenge. Step 606 processes the license challenge. This step can be performed in any suitable way. For example, in at least some embodiments, processing the license challenge can include accessing the referral list and un-protecting the referral list as by decrypting or otherwise verifying the integrity of the referral list. Step 608 applies policy associated with one or more referrers on the referral list. Examples of policy that can be applied are provided above. In addition, policies can include revenue sharing that is spread amongst referers appearing on the referral list. For example, the top referrer might receive a larger percentage of a license fee than those referers appearing below the top referrer. Step 610 modifies and protects the referral list. For example, the referral list can be modified as by inserting, at the top of the list, the user from whom the referral list was received. The referral list can then be protected in any suitable way, examples of which are provided above. Step 612 sends a license and the protected referral list back to the user.

Step 614 receives, from the server, the license and the modified, protected referral list. At this point, software executing on the recipient's computing device can reassociate the protected referral list with its associated content. For example, in at least some embodiments, the modified protected referral list can be re-embedded in the content.

Combining Multiple Referral Lists

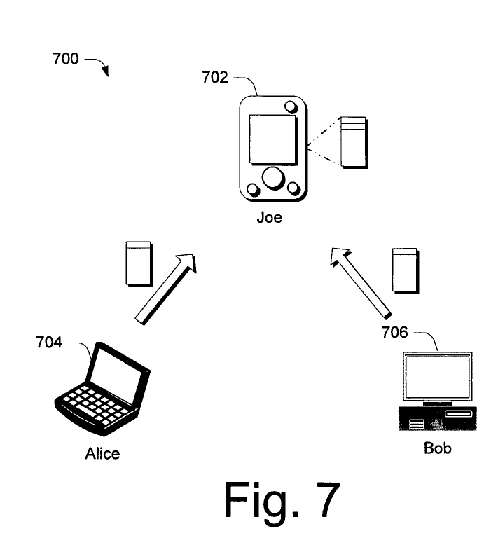

In some embodiments, referral lists that are received from different users can be combined. These referral lists can be combined either on a client computing device or by the server. As an example, consider FIG. 7.

There, a system in accordance with one or more embodiments as shown generally at 700. In this example, system 700 includes three different client computing devices 702, 704, and 706. Here, Joe has received content from both Alice and Bob. Assume that the content corresponds to a common multimedia file. In this case, two different referral lists are provided and each can be different from the other. In this particular example, client device 702 can combine the referral lists as indicated. These combined referral lists can then be sent to the server using any of the processes described above. For example, client device 702 can physically combine the referral lists and then forward the combined referral lists to the server for processing. Alternately or additionally, the client device can provide both protected referral lists in its communication to the server. At the server, the protected referral lists can be unprotected by the server, processed and modified as described above. A single combined referral list can then be returned to the client device 702.

Generating a Referral List On-The-Fly

In one or more embodiments, referral lists can be generated on the fly by a client computing device. For example, a referral list can be generated using license information that is contained in or otherwise accompanies the content. Specifically, content can include a number of existing licenses associated with the content. Information from these existing licenses can be used to generate a referral list. For example, existing licenses typically appear in an order from which can be implied a referral order. That is, the order of the licenses can be used to ascertain an order in which users consumed or referred content. Alternately or additionally, a referral order can be implied using parameters such as when each license was last used, when each license was embedded with the content, and/or when each license was issued.

This information can be used to build a referral list which is then sent to the server and processed as described above.

Example System

FIG. 8 illustrates an example computing device 800 that can implement the various embodiments described above. Computing device 800 can be, for example, various computing device or servers, such as those illustrated in FIG. 1 or any other suitable computing device.

Computing device 800 includes one or more processors or processing units 802, one or more memory and/or storage components 804, one or more input/output (I/O) devices 806, and a bus 808 that allows the various components and devices to communicate with one another. Bus 808 represents one or more of any of several types of bus structures, including a memory bus or memory controller, a peripheral bus, an accelerated graphics port, and a processor or local bus using any of a variety of bus architectures. Bus 808 can include wired and/or wireless buses.

Memory/storage component 804 represents one or more computer storage media. Component 804 can include volatile media (such as random access memory (RAM)) and/or nonvolatile media (such as read only memory (ROM), Flash memory, optical disks, magnetic disks, and so forth). Component 804 can include fixed media (e.g., RAM, ROM, a fixed hard drive, etc.) as well as removable media (e.g., a Flash memory drive, a removable hard drive, an optical disk, and so forth).

One or more input/output devices 806 allow a user to enter commands and information to computing device 800, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Various embodiments described above can enable referral lists to be used in connection with distributed content to protect a referral infrastructure that is used with such content. In at least some embodiments, referral lists are protected using digital rights management (DRM) techniques. The DRM techniques can be used for a number of purposes including securely establishing a referring consumer, securely maintaining a chain of referring entities through distribution tracking, and maintaining control over the referral lists associated with distributed content. In at least some embodiments, DRM techniques are utilized to protect referral lists that are used in multi-level marketing networks.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
receiving content having an associated referral list;
sending at least the referral list to a server; and
receiving, from the server, a modified referral list that includes a user from which the referral list was sent to the server.

2. The method of claim 1, wherein the referral list is embedded in the content.

3. The method of claim 1, wherein the referral list includes an ID associated with a source from which the content was received.

4. The method of claim 1 further comprising reassociating the modified referral list with the content.

5. The method of claim 4, wherein said reassociating comprises embedding the modified referral list in the content.

6. The method of claim 1, wherein the referral list comprises a protected referral list.

7. The method of claim 1, wherein the modified referral list comprises a modified, protected referral list.

8. The method of claim 1, wherein said sending comprises issuing a license challenge.

9. The method of claim 8, wherein said receiving a modified referral list further comprises receiving a license associated with the content.

10. The method of claim 1 further comprising combining multiple referral lists.

11. The method of claim 1 further comprising generating a referral list at a client computing device.

12. A computer-implemented method comprising:
receiving a referral list that is associated with content received by a user, wherein the referral list includes an ID associated with a source from which the content was received by the user; and
applying policy associated with one or more referrers on the referral list;
modifying the referral list by inserting the user from whom the referral list was received.

13. The method of claim 12, wherein said policy can include revenue-sharing amongst one or more referrers on the referral list.

14. The method of claim 12, wherein said modifying comprises inserting the user at a top of the referral list and further comprising sending a modified referral list back to the user.

15. The method of claim 12 further comprising applying protections to the modified referral list to ensure that unauthorized entities are unable to manipulate content of the modified referral list and sending the modified referral list back to the user.

16. The method of claim 12, wherein said receiving comprises receiving a license challenge that includes the referral list.

17. The method of claim 12, wherein said sending further comprises sending a license associated with the content back to the user.

18. The method of claim 12 further comprising combining multiple referral lists.

19. A server comprising:
one or more computer readable storage media;
computer readable instructions on the one or more computer readable storage media which, when executed, implement a method comprising:
receiving a referral list that is associated with content received by a user, wherein the referral list includes an ID associated with a source from which the content was received by the user;
applying policy associated with one or more referrers on the referral list;
modifying the referral list by inserting the user from whom the referral list was received;
applying protections to the modified referral list to ensure that unauthorized entities are unable to manipulate content of the modified referral list; and
sending a modified protected referral list back to the user.

20. The system of claim 19, wherein said policy can include revenue-sharing amongst one or more referrers on the referral list.
